(19) United States
(12) Patent Application Publication
(10) Pub. No.: US 2012/0129143 A1
(43) Pub. Date: May 24, 2012

(54) System and method for generating a plot of a digital print

(75) Inventor: Lane Merrifield, Kelowna (CA)

(73) Assignee: DISNEY ENTERPRISES, INC., BURBANK, CA (US)

(21) Appl. No.: 12/927,642

(22) Filed: Nov. 19, 2010

(51) Int. Cl. G09B 3/00

(52) U.S. Cl. 434/322

(57) ABSTRACT

There is provided a system and method for generating a plot of a digital print. According to an exemplary embodiment, a method includes presenting a micro event of the digital print, the digital print having a plurality of micro events, each micro event having a plurality of outcomes and polling for user input for the micro event while presenting the micro event. The method further includes determining an outcome of the micro event based on the polling for user input and selecting a scenario from a scenario map based on the outcome of said micro event. Finally, the method includes generating a storyline of the plot based on the scenario selected from the scenario map.

### BACKGROUND OF THE INVENTION

1. Field of the Invention

The present invention relates generally to the production of entertainment content. More particularly, the present invention relates to digital content.

2. Background Art

The emergence of the portable computer as well as online distribution channels have driven demand to transition traditional printed storytelling mediums such as books and comics into the digital realm. Transitioning these traditional mediums presents the challenge of balancing new interactive aspects allowed for in the digital realm with conventional aspects of the traditional print mediums. For example, one approach to transitioning a traditional print media into the digital realm has focused on converting the traditional storytelling medium into a fully interactive videogame. However, this approach fundamentally alters the storytelling experience provided to the user when consuming the digital media as compared to the traditional print media.

Other approaches have focused on precisely representing a traditional print media in digital form to mirror the storytelling experience provided to the user when consuming the traditional print medium. For example, a digital comic book may consist of multiple digital images with text where each digital image is a faithful representation of a static image traditionally presented as a page on paper. However, this approach does not take advantage of the opportunities available in the digital realm to enhance the storytelling experience offered by traditional storytelling mediums.

Accordingly, there is a need to overcome the drawbacks and deficiencies in the art by providing a system and method for generating a plot of a digital print.

### SUMMARY OF THE INVENTION

A system and method for generating a plot of a digital print, substantially as shown in and/or described in connection with at least one of the figures, as set forth more completely in the claims.

### BRIEF DESCRIPTION OF THE DRAWINGS

The features and advantages of the present invention will become more readily apparent to those ordinarily skilled in the art after reviewing the following detailed description and accompanying drawings, wherein:

FIG. 1 presents a block diagram of a system for generating a plot of a digital print, according to one embodiment of the present invention.

FIG. 2 shows a flowchart describing an overview of the steps, by which a system may generate a plot of a digital print, according to one embodiment of the present invention.

FIG. 3 shows a flowchart describing the steps, by which a system may generate a plot of a digital print, according to one embodiment of the present invention.

### DETAILED DESCRIPTION OF THE INVENTION

The present application is directed to a system and method for generating a plot of a digital print. The following description contains specific information pertaining to the implementation of the present invention. One skilled in the art will recognize that the present invention may be implemented in a manner different from that specifically discussed in the present application. Moreover, some of the specific details of the invention are not discussed in order not to obscure the invention. The specific details not described in the present application are within the knowledge of a person of ordinary skill in the art. The drawings in the present application and their accompanying detailed description are directed to merely exemplary embodiments of the invention. To maintain brevity, other embodiments of the invention, which use the principles of the present invention, are not specifically described in the present application and are not specifically illustrated by the present drawings.

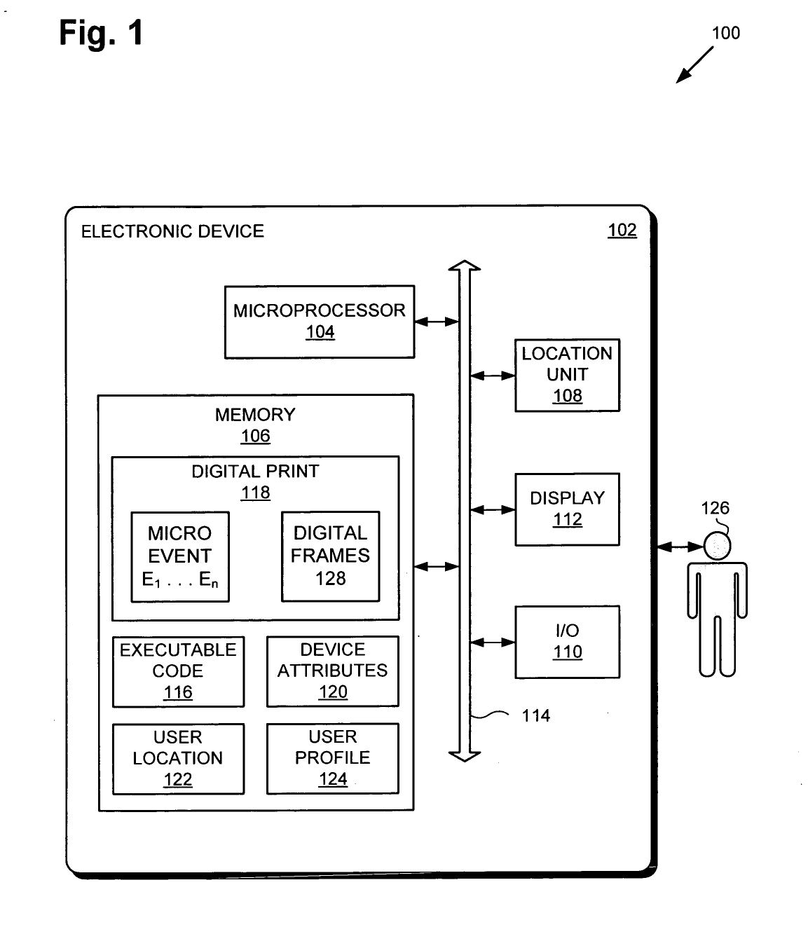

FIG. 1 presents a block diagram of a system for generating a plot of a digital print, according to one embodiment of the present invention. In the embodiment of FIG. 1, system 100 comprises electronic device 102 including microprocessor 104, memory 106, location unit 108, I/O 110, and display 112, which are coupled to one another through bus 114. As shown in FIG. 1, memory 106 includes executable code 116, digital print 118, device attributes 120, user location 122, and user profile 124. FIG. 1 also shows user 126 utilizing digital print 118 on electronic device 102.

Electronic device 102 comprises microprocessor 104 configured for generating a plot of digital print 118. Microprocessor 104, memory 106, location unit 108, I/O 110, and display 112 can communicate using bus 114 to generate the plot of digital print 118. It will be appreciated that microprocessor 104, memory 106, location unit 108, I/O 110, and display 112 can communicate using other means, for example, using a plurality of dedicated lines, or a combination of buses and dedicated lines.

It should be noted that the embodiment shown FIG. 1 is one specific embodiment and is simplified for clarity. Alternative embodiments can include varying components and configurations. For example, in FIG. 1, microprocessor 104, memory 106, location unit 108, I/O 110, and display 112 are each included in electronic device 102, which can comprise, for example, one of a personal computer, a portable gaming device, a mobile handset, and a touch-screen device. However, in other embodiments, various components of system 100 may be, for example, distributed across multiple electronic devices, or may be external discrete components connected to electronic device 102. Furthermore, in some embodiments any of the various components of system 100 may be coupled to one another through a server. For example, in one embodiment electronic device 102 can be coupled to display 112 and location unit 108 through a server.

In the present embodiment, microprocessor 104 is configured to operate in accordance with executable code 116 stored in memory 106 to generate the plot of digital print 118. As shown in FIG. 1, executable code 116 is stored in memory 120, which can comprise random access memory (RAM). In one embodiment, executable code 116 can comprise a software program for presenting digital prints, such as, digital print 118, which can each be stored, for example, in a respective file container. In other embodiments, executable code 116 comprises an executable file, which includes at least digital print 118. In some embodiments digital print 118 can be stored on a server. In some embodiments digital print 118 may be stored across multiple files.

Also in the present embodiment, microprocessor 104 is configured to present digital print 118 to user 126. Digital print 118 can comprise a digital representation of a traditionally printed storytelling medium. Digital print 118 can comprise, for example, any of a digital comic book, digital graphic novel, and digital picture book.

As shown in FIG. 1, digital print 118 includes plurality of micro events E₁ through Eₙ and digital frames 128 in memory 106. In digital print 118, each of digital frames 128 typically comprises a substantially static digital image, which can be presented on display 112 by microprocessor 104. In some embodiments digital frames 128 can include motion elements. For example, one of digital frames 128 may include a digital image of a stormy sky, which is substantially static, but includes periodic flashes of lightning bolts. As another example, one of digital frames 128 may include layers of static digital images used to simulate motion using, for example, parallax scrolling.

Microprocessor 104 can sequentially present some of digital frames 128 to facilitate a storytelling narrative of the plot of digital print 118. For example, in one embodiment digital print 118 comprises a digital comic book and each of digital frames 128 comprises a respective panel of the digital comic book. In other embodiments, digital print 118 comprises a digital picture book, such as a children's book, where each of digital frames 128 comprises a page of the children's book.

Also shown in FIG. 1, digital print 118 includes plurality of micro events E₁ through Eₙ. Micro events E₁ through Eₙ are interactive events of the plot of digital print 118 each having a plurality of determinable outcomes where a particular outcome is used to generate the plot of digital print 118. For example, micro event E₁ has a plurality of outcomes where microprocessor 104 is configured to determine a particular outcome of micro event E₁ based on user input from, for example user 126. Microprocessor 104 is further configured to use the determined outcome of micro event E₁ to generate the plot of digital print 118. Each of interactive micro events E₁ through Eₙ can be presented along with an at least one associated digital frames 128 and are interspersed periodically throughout the plot of digital print 118. Thus, the storytelling experience provided to user 126 when consuming digital print 118 can closely correspond to that of traditional print media while enhancing the immersive aspects of the storytelling experience.

In some embodiments, microprocessor 104 is configured to utilize any of device attributes 120, user location 122, and user profile 124 to generate the plot of digital print 118. For example, in some embodiments microprocessor 104 is configured to select a micro event to present from among micro events E₁ through Eₙ based on any of device attributes 120, user location 122, and user profile 124 to generate the plot of digital print 118. In other embodiments, microprocessor 104 is configured to generate a storyline of the plot of digital print 118 based on any of device attributes 120, user location 122, and user profile 124 to generate the plot of digital print 118. In this way, the immersive aspects of the storytelling experience provided to user 126 when consuming digital print 118 can be further enhanced.

Device attributes 120 comprise information describing electronic device 102. As examples, device attributes 120 can include that electronic device 102 has location unit 108, is a portable device, is a desktop computer, has access to a computer network, that I/O 110 supports touch screen based input, that I/O 110 supports motion sensing based input, that location unit 108 has a Global Positioning System (GPS) receiver, or other information related to the components and/or capabilities of electronic device 102.

User location 126 comprises the geographical location of user 126. In some embodiments microprocessor 104 is configured to determine and update user location 126 utilizing location unit 108. For example, microprocessor 104 can be configured to utilize location unit 108 to correlate an internet protocol (IP) address of electronic device 102 with a particular city, state, and region, for example, or for performing a reverse GPS search when electronic device 102 comprises a GPS compatible device, such as a suitably equipped mobile communication device or tablet computer.

User profile 124 comprises information describing a user, such as user 126, and in some embodiments may be password protected. User profile 124 can comprise, for example, information about the age, gender, hobbies, or any other information related to user 126. User profile 124 can also comprise, for example, a “friends list” of other users of a computer service.

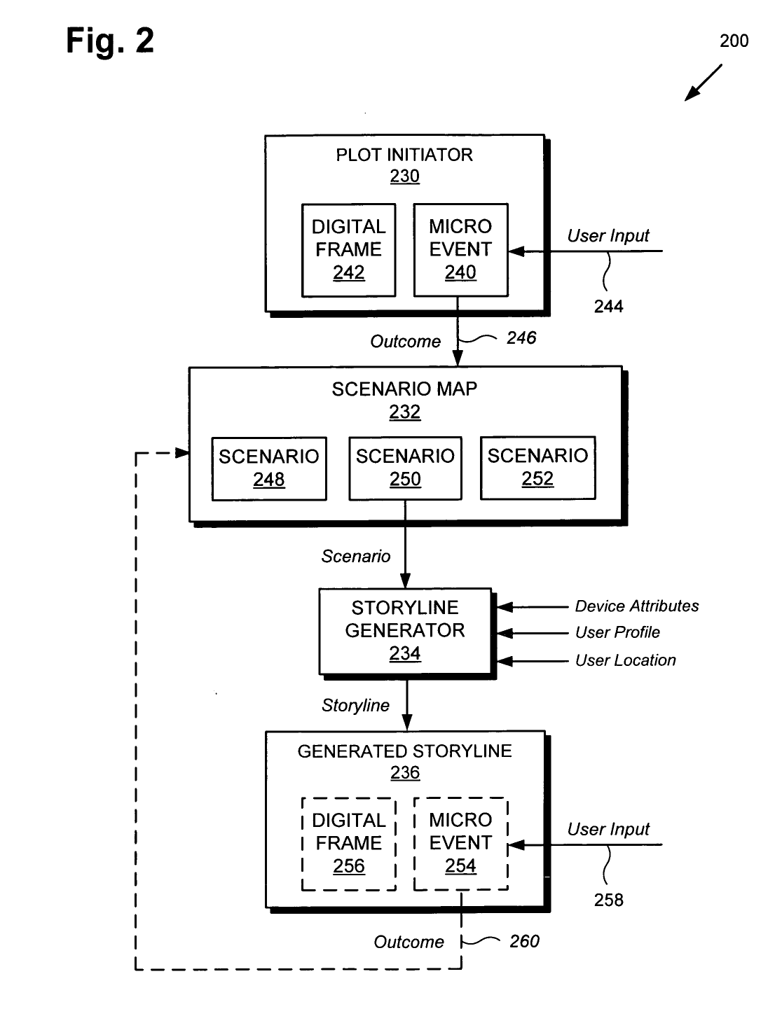

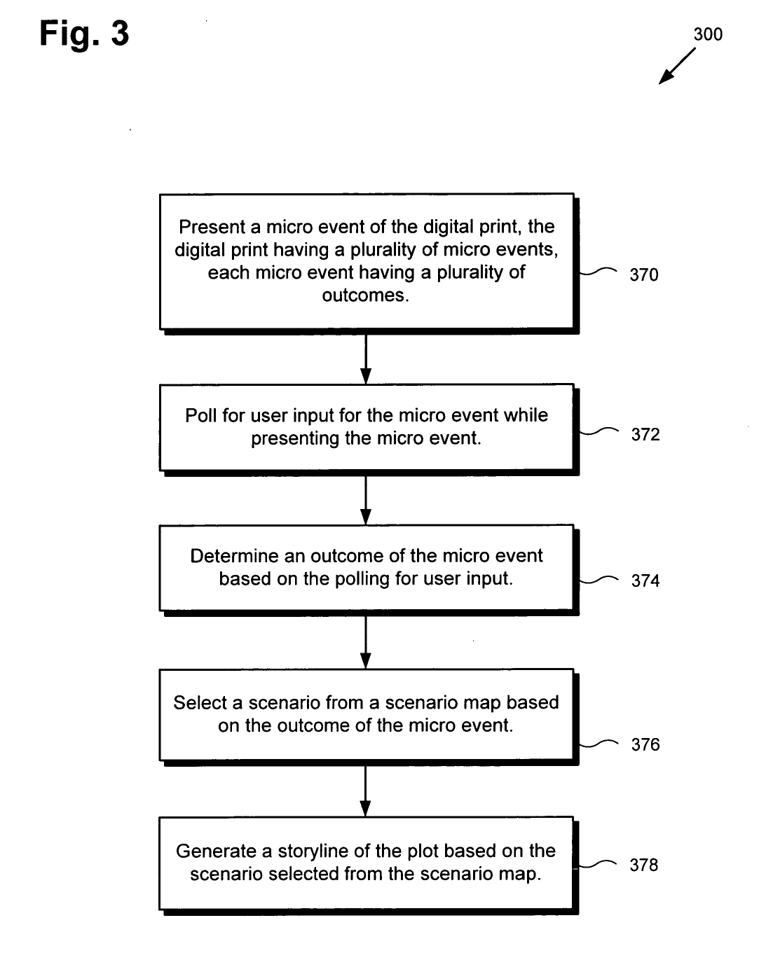

Referring now to FIG. 2, FIG. 2 shows a flowchart describing an overview of the steps, by which a system may generate a plot of a digital print, according to one embodiment of the present invention. Flowchart 200 shows plot initiator 230, scenario map 232, storyline generator 234, and generated storyline 236 for generating a plot of a digital print, for example, digital print 118 in FIG. 1. Flowchart 200 will be described in more detail with respect to FIG. 3.

FIG. 3 shows flowchart 300 describing the steps, by which system 100 in FIG. 1 may generate a plot of digital print 118. Certain details and features have been left out of flowchart 300 that are apparent to a person of ordinary skill in the art. For example, a step may comprise one or more substeps or may involve specialized equipment or materials, as known in the art. While steps 370 through 378 indicated in flowchart 300 are sufficient to describe one embodiment of the present invention, other embodiments of the invention may utilize steps different from those shown in flowchart 300.

Referring to step 370 of flowchart 300 in FIG. 3, flowchart 200 of FIG. 2, and system 100 in FIG. 1, step 370 of flowchart 300 comprises microprocessor 104 presenting micro event 240 from micro events E₁ through Eₙ of digital print 118. Microprocessor 104 is configured to present micro event 240 to user 126 using memory 106, location unit 108, I/O 110, and display 112. As described above, in some embodiments microprocessor 104 can be configured to select micro event 240 to present from among micro events E₁ through Eₙ based on any of device attributes 120, user location 122, and user profile 124 to generate the plot of digital print 118. For example, microprocessor 104 can be configured to select micro event 240, which requires a GPS receiver based on device attributes 120. In other embodiments, microprocessor 104 can be configured to select a mature themed micro event 240 using the age of user 126 based on user profile 124. As another example, microprocessor 104 can be configured to select micro event 240, which requires the user to work with another user, based on user location 122 and the location of the other user.

As shown in flowchart 200, in one embodiment, digital print 118 includes plot initiator 230 where microprocessor 104 can be configured to present micro event 240 in plot initiator 230. Plot initiator 230 comprises an introductory portion of the plot of digital print 118, which can be presented to user 126 on display 112 to begin the plot of digital print 118. In some embodiments, microprocessor 104 can be configured to generate plot initiator 230 based on, for example, at least one of device attributes 108, user location 112, and user profile 124. In other embodiments, plot initiator 230 can comprise a prewritten portion of the plot of digital print 118. Furthermore, microprocessor 104 can be configured to select plot initiator 230 from among a plurality of prewritten plot initiators of digital print 118 based on, for example, at least one of device attributes 108, user location 112, and user profile 124.

Plot initiator 230 comprises one or more digital frames 128 of digital print 118 where microprocessor 104 is configured display at least one of digital frames 128, such as digital frame 242, on display 112 to present micro event 240. Plot initiator 230 can include other digital frames 128 which are not displayed to present micro event 240. As a specific example, digital print 118 can comprise a Spider-Man digital comic book. Microprocessor 104 can be configured to sequentially present some of digital frames 128 of plot initiator 230 to user 126 using display 112 of electronic device 102 to facilitate a storytelling narrative of the plot of digital print 118. For example, the presented digital frames 128 may progressively show digital images of Spider-Man swinging along buildings in a city looking for criminal activity along with various text bubbles.

Microprocessor 104 can subsequently present micro event 240 using digital frame 242 displayed on display 112 comprising a digital image of Doctor Octopus (Doc Oc) climbing the walls of a bank building and Sandman approaching the door of the bank building. A text bubble of Spider-Main can be in digital frame 242 reading “Look what we have here . . . Doc Oc and Sandman are going to rob that bank. I can't stop them both . . . I wonder who I should go after first?” Digital frame 242 can also include text based or audible instructions for user 126 to select which of the two villains (Doc Oc or Sandman) Spider-Man should pursue. It is noted that in some embodiments the plot of digital print 118 may begin with digital frame 242.

Referring to step 372 of flowchart 300 in FIG. 3, flowchart 200 of FIG. 2, and system 100 in FIG. 1, step 372 of flowchart 300 comprises microprocessor 104 polling I/O 110 for user input 244 for micro event 240 while presenting micro event 240. As shown in FIG. 2, micro event 240 can receive user input 244, which can be provided by user 126 for interactivity. User input 244 can comprise, for example, touch-based input, motion sensing input, mouse input, audible input from a microphone of electronic device 102, or other forms of input which can be provided by user 126 for micro event 240.

Continuing with the example of the Spider-Man digital comic book, electronic device 104 can comprise a touch screen device where I/O 110 supports touch-based input. Thus, user 126 can press a finger on Doc Oc in the digital image of digital frame 242 thereby providing user input 244 to micro event 240 to indicate that user 126 has selected to pursue Doc Oc. Microprocessor 104 can be configured to provide feedback to user 126 responsive to polling I/O 110 for user input 244. For example, a spider web may appear in digital frame 242 covering Doc Oc responsive to micro event 240 receiving user input 244. Furthermore, a sound effect may play on a speaker (not shown) of electronic device 102. Alternatively, user 126 can select to pursue Sandman by pressing a finger on Sandman. It is noted that in some embodiments micro event 244 may not receive user input 244. For example, after a period of time of microprocessor 104 polling I/O 110 for user input 244, microprocessor 104 can be configured to determine that user input 244 has not been received from user 126. Thus, for example, after a period of time, digital frame 242 can show a text bubble of Spider-Man on display 112 that says, “If I can warn the security guards at the bank they could seal the vault.” This can indicate that the user has selected to not pursue Doc Oc or Sandman.

Referring to step 374 of flowchart 300 in FIG. 3, flowchart 200 of FIG. 2, and system 100 in FIG. 1, step 374 of flowchart 300 comprises microprocessor 104 determining outcome 246 of micro event 240 based on the polling of I/O 110 for user input 244. As described above, each of micro events E₁ through Eₙ have a plurality of determinable outcomes. Returning to the Spider-Man digital comic book example, outcome 246 may be that user 126 has selected to pursue Doc Oc, Sandman, or has selected to not pursue either as described above. In other embodiments outcome 246 can be that Spider-Man has failed or alternatively succeeded in diffusing a bomb based on user input 244 received by micro event 240 where user 126 can cut wires of the bomb via I/O 110.

Referring to step 376 of flowchart 300 in FIG. 3, flowchart 200 of FIG. 2, and system 100 in FIG. 1, step 376 of flowchart 300 comprises microprocessor 104 selecting scenario 250 from scenario map 232 based on outcome 246 of micro event 240. As shown in FIG. 2, outcome 246 is provided to scenario map 232. Scenario map 232 of digital print 118 comprises a plurality of scenarios for the plot of digital print 118, including scenarios 248, 250, and 252. In scenario map 232, scenarios 248, 250, and 252 are respective scenarios for the plot of digital print 118 and are logically related to a respective determinable outcome of micro event 240. For example, scenario 250 is logically related to outcome 246. More particularly, scenarios 248, 250, and 252 represent respective scenarios for generated storyline 236 of the plot of digital print 118. In some embodiments each determinable outcome of micro even 240 has a single corresponding scenario in scenario map 232. In other embodiments multiple scenarios can correspond to a particular determinable outcome. Still in other embodiments a scenario can correspond with multiple determinable outcomes so long as at least one of the other determinable outcomes corresponds to another scenario.

Returning to the Spider-man digital comic book as an example, if outcome 246 is that user 126 has selected to pursue Doc Oc, scenario 248 can be that Spider-Man fights Doc Oc. If outcome 246 is that user 126 has selected to pursue Sandman, scenario 250 can be that Spider-Man fights Sandman. If outcome 246 is that user 126 has selected to not pursue Doc Oc or Sandman, scenario 252 can be that Spider-Man searches for a way to warn the security guards at the bank.

Referring to step 378 of flowchart 300 in FIG. 3, flowchart 200 of FIG. 2, and system 100 in FIG. 1, step 378 of flowchart 300 comprises microprocessor 104 generating storyline 236 of the plot of digital print 118 based on scenario 250 selected from scenario map 232. As shown in FIG. 2, microprocessor 104 is configured to utilize storyline generator 234 for generating storyline 236 of digital print 118. Each scenario in scenario map 232 can have an association with at least one of digital frames 128, which can be used generate storyline 236. In the Spider-Man digital comic book example, for instance, scenario 248 can have associated digital frames 128 sequentially depicting the fight scene between Spider-Man and Doc Oc. Scenario 250 can have associated digital frames 128 sequentially depicting the fight scene between Spider-Man and Sandman. Scenario 252 can have associated digital frames 128 sequentially depicting Spider-Man searching for a way to warn the security guards of the bank about an impending robbery attempt.

In some embodiments, microprocessor 104 can be configured to generate storyline 236 using storyline generator 234 based on any of device attributes 120, user location 122, and user profile 124. As shown in FIG. 2, generated storyline 236 can optionally include micro event 254, which can be presented using digital frame 256 similar to micro event 240. Alternatively, generated storyline 236 can comprise an ending portion of the plot of digital print 118, which can be presented to user 126 to conclude the plot of digital print 118. Similar to plot initiator 230, generated storyline 236 comprises one or more digital frames 128 of digital print 118 where at least one of digital frames 128, such as digital frame 256 can be displayed to present micro event 254. Generated storyline 236 can include other digital frames 128 which are not displayed to present micro event 240.

Microprocessor 104 can be configured to select micro event 254 from micro events E₁ through Eₙ or from digital frames 128 in generating storyline 236 based on any of device attributes 120, user location 122, and user profile 124. In the Spider-Man digital comic book example, for instance, generated storyline 236 can include a character that helps Spider-Man having the same name, gender and hair color as user 126 based on user profile 124.

As another example, where user profile 124 indicates that user 126 likes baseball, generated storyline 236 can have the fight between Sandman and Spider-Man conclude in a baseball stadium or can have a baseball themed micro event 254. Furthermore, if user profile 124 indicates that user 126 is consuming digital print 118 with a friend, generated storyline 236 can have micro event 254 compatible with user input 258 from more than one user.

In some embodiments microprocessor 104 can determine that user 126 is near another user based on user location 122. The selected micro event 254 of generated storyline 236 can then have user 126 work with the other user to fight Sandman. Furthermore, device attributes 120 may indicate that electronic device 102 is a portable device with a camera. Micro event 254 can then have user 126 find and take a picture of a cell phone so that Spider-Man can call the bank to warn the security guards in the case of scenario 252.

Subsequently, microprocessor 104 can present generated storyline 236 of the plot. Generated storyline 236 can be presented on display 112 similar to plot initiator 230 as described above. Furthermore, micro event 254 can be presented similar to micro event 240 as described above and microprocessor 104 can determine outcome 260 of micro event 254 based on polling I/O 110 for user input 258.

Thus, according to various embodiments, as set forth in FIGS. 1-3, the present invention provides for a system and method for generating a plot of a digital print. The digital print includes a plurality of micro events and digital frames. The digital frames can be sequentially presented to facilitate a storytelling narrative of the plot of the digital print with the micro events interspersed periodically throughout. The micro events are interactive events of the plot of the digital print, each having a plurality of determinable outcomes where a particular outcome is used to generate the plot of digital print. Thus, according to various embodiment, the storytelling experience provided to a user when consuming the digital print can closely correspond to that of traditional print media while enhancing the immersive aspects of the storytelling experience.

From the above description of the invention it is manifest that various techniques can be used for implementing the concepts of the present invention without departing from its scope. Moreover, while the invention has been described with specific reference to certain embodiments, a person of ordinary skills in the art would recognize that changes can be made in form and detail without departing from the spirit and the scope of the invention. As such, the described embodiments are to be considered in all respects as illustrative and not restrictive. It should also be understood that the invention is not limited to the particular embodiments described herein, but is capable of many rearrangements, modifications, and substitutions without departing from the scope of the invention.

What is claimed is:

1. A method for generating a plot of a digital print, said method comprising:
presenting a micro event of the digital print, the digital print having a plurality of micro events, each micro event having a plurality of outcomes;
polling for user input for said micro event while presenting said micro event;
determining an outcome of said micro event based on said polling for user input;
selecting a scenario from a scenario map based on the outcome of said micro event;
generating a storyline of said plot based on said scenario selected from said scenario map.

2. The method of claim 1, comprising selecting said micro event to present from said plurality of micro events based on any of a device attribute, a user location, and a user profile.

3. The method of claim 1, comprising generating said storyline of said plot based on a user location.

4. The method of claim 2, wherein said storyline is based on said user location relative to another user.

5. The method of claim 1, comprising generating said storyline of said plot based on a user profile.

6. The method of claim 1, comprising generating said storyline of said plot based on a device attribute.

7. The method of claim 1, wherein said micro event is presented using a digital frame displayed on a display.

8. The method of claim 1, wherein said digital print comprises a digital comic book.

9. The method of claim 1, wherein said digital print comprises a digital picture book.

10. The method of claim 1, comprising presenting said generated storyline of said plot.

11. A system for generating a plot of a digital print, said system comprising a microprocessor, said microprocessor configured to:
present a micro event of the digital print, the digital print having a plurality of micro events, each micro event having a plurality of outcomes;
poll for user input for said micro event while presenting said micro event;
determine an outcome of said micro event based on said polling for user input;
select a scenario from a scenario map based on the outcome of said micro event;
generate a storyline of said plot based on said scenario selected from said scenario map.

12. The system of claim 1, said microprocessor configured to select said micro event to present from said plurality of micro events based on any of a device attribute, a user location, and a user profile.

13. The system of claim 1, said microprocessor configured to generate said storyline of said plot based on a user location.

14. The system of claim 2, wherein said storyline is based on said user location relative to another user.

15. The system of claim 1, said microprocessor configured to generate said storyline of said plot based on a user profile.

16. The system of claim 1, said microprocessor configured to generate said storyline of said plot based on a device attribute.

17. The system of claim 1, wherein said micro event is presented using a digital frame displayed on a display.

18. The system of claim 1, wherein said digital print comprises a digital comic book.

19. The system of claim 1, wherein said digital print comprises a digital picture book.

20. The system of claim 1, said microprocessor configured to present said generated storyline of said plot.
